(19) United States
(12) Patent Application Publication
(10) Pub. No.: US 2020/0240600 A1
(43) Pub. Date: Jul. 30, 2020

(54) Curlable Lamp

(71) Applicant: Shenzhen Fototech Photographic Equipment Co., Ltd, Henzhen City (CN)

(72) Inventor: Chai Yee Ho, Henzhen City (CN)

(21) Appl. No.: 16/398,699

(22) Filed: Apr. 30, 2019

(30) Foreign Application Priority Data
Jan. 28, 2019 (CN) 201920143687.2

(51) Int. Cl. F21S 4/24; F21S 2/00; F21V 23/00; F21V 31/00; H05B 33/08

(52) U.S. Cl. CPC F21S 4/24; F21S 2/005; F21Y 2115/10; F21V 31/005; H05B 33/0863; F21V 23/001

(57) ABSTRACT

Disclosed is a curlable lamp, comprising an illuminating component and a waterproof soft sheet, wherein a flexible lamp bead positioning block is arranged between the illuminating component and the waterproof soft sheet, the illuminating component comprises lamp bead strips, which connect with wiring boards, the lamp bead strips comprise flexible circuit boards and lamp beads, the lamp beads are connected in series or in parallel on flexible circuit boards, hole sites are arranged on the flexible lamp bead positioning block at positions corresponding to the lamp beads, shapes and sizes of the hole sites are matched with the lamp beads, the lamp beads are bonded and fixed in the hole sites, and a metal film radiator is arranged on back of the lamp bead strips. The curlable lamp of the present disclosure has good heat dissipation. The lamp beads are bonded and fixed to make the curlable lamp more compact and integrated. Especially when the lamp is curled, the lamp beads will not be disarrayed, so that the light effect is more uniform. During maintenance, only the lamp bead strips to be repaired needs to be taken down and replaced, which is convenient and quick. Additionally, the lamp can be curled to save space when not in use.

### RELATED APPLICATION

The present disclosure claims all the benefits of the utility model application No. 201920143687.2 which was filed on Jan. 28, 2019 before the China National Intellectual Property Office and was entitled “Curlable Lamp”, which is incorporated herein by reference in its entirety.

### FIELD

The present disclosure relates to the technical field of lamps applied to photography and video shooting, in particular to a curlable lamp.

### BACKGROUND

Curlable lamp is a kind of lamp used to supplement light in photography and video shooting. When the curlable lamp is used outdoors, it is inevitably exposed to rain. Due to poor sealing performance, there is a possibility of water leakage, resulting in short circuit of lamp beads and damage to the curlable lamp after the curlable lamp is wetted. As each lamp bead is connected in series, once one of lamp beads is damaged, the whole lamp beads will not be usable. During maintenance, the whole lamp bead strip needs to be replaced, which increases the replacement difficulty and causes great waste. In addition, when the curlable lamp is used, the lamp beads will generate large amount of heat, if it is not dissipated in time, the service life of the lamp beads will be greatly reduced, causing great inconvenience and loss to the user.

### SUMMARY

The present disclosure relates to a curlable lamp, comprising an illuminating component and a waterproof soft sheet, wherein a flexible lamp bead positioning block is arranged between the illuminating component and the waterproof soft sheet, the illuminating component comprises lamp bead strips, which connect with wiring boards, the lamp bead strips comprise flexible circuit boards and lamp beads, the lamp beads are connected in series or in parallel on the flexible circuit boards, hole sites are arranged on the flexible lamp bead positioning block at positions corresponding to the lamp beads, shapes and sizes of the hole sites are matched with the lamp beads, the lamp beads are bonded and fixed in the hole sites, and a metal film radiator is arranged on back of the lamp bead strips.

The curlable lamp of the present disclosure provides good heat dissipation. The lamp beads are bonded and fixed, so that the curlable lamp is more compact and integrated. Especially when the lamp is curled, the lamp beads will not be disarrayed, so that the light effect is more uniform. During maintenance, only the lamp bead strips to be repaired needs to be taken down and replaced, which is convenient and quick. Additionally, the lamp can be curled to save space when not in use.

In some embodiments, the number of the hole sites is the same as the number of the lamp beads, which ensures that each lamp bead is bonded and fixed in the hole sites.

In some embodiments, a waterproof cloth is arranged on the back of the metal film radiator and the waterproof cloth and the four sides of the waterproof soft sheet are bonded. This arrangement prevents water from penetrating into the interior, which causes the lamp beads to be short-circuited and unusable.

In some embodiments, a hem is arranged on overlapping formed after the waterproof cloth and edges of the waterproof soft sheet are bonded, which plays a reinforcing role and increases the roundness and beauty of the lamp edge.

In some embodiments, the curlable lamp of the present disclosure further comprises an input connecting wire, wherein a first outlet and a second outlet are arranged on the waterproof cloth and the metal film radiator, respectively, through which the input connecting wire passes. The input connecting wire is connected with the wiring board after sequentially passing through the first outlet and the second outlet. The input connecting wire is electrically connected with the lamp beads through the wiring board to control the lamp effect of the lamp beads.

In some embodiments, a waterproof rubber pad is arranged between the waterproof cloth and the metal film radiator. The waterproof rubber pad is fixed on the waterproof cloth through a first input wire fixed base and a second input wire fixed base. A third outlet, a fourth outlet and a fifth outlet are arranged on the waterproof rubber pad, the first input wire fixed base and the second input wire fixed base, respectively, through which the input connecting wire passes. The input connecting wire is connected with the wiring board after sequentially passing through the fourth outlet, the first outlet, the third outlet, the fifth outlet and the second outlet. The waterproof rubber pad prevents water from penetrating into the interior through the outlet. The waterproof rubber pad is fixed on the waterproof cloth through the independent first and second input wire fixed base, which makes the installation convenient and firm.

In some embodiments, the waterproof rubber pad is a high-elasticity waterproof silicone pad, which improves the waterproof performance.

In some embodiments, the lamp beads are LED lamp beads.

In some embodiments, the present disclosure further comprises a light controller, wherein the light controller comprises an output connecting wire, a light brightness adjusting knob and a light color temperature adjusting knob. The input connecting wire is electrically connected with the output connecting wire. The light controller can control the light brightness and color of the light beads.

### BRIEF DESCRIPTION OF THE DRAWINGS

FIG. 1 shows a structural schematic view of the curlable lamp of the present disclosure after disassembled.

FIG. 2 shows an enlarged view of part A in FIG. 1.

FIG. 3 shows a front view of the curlable lamp of the present disclosure after assembled.

FIG. 4 shows a rear view of the curlable lamp of the present disclosure after assembled.

FIG. 5 shows a schematic view of the curlable lamp of the present disclosure after curled.

FIG. 6 shows another schematic view of the curlable lamp of the present disclosure after curled.

FIG. 7 shows a schematic structural view of the light controller of the present disclosure.

### DETAILED DESCRIPTION

The present disclosure will be described in further detail below with reference to the accompanying drawings, in order to facilitate those skilled in the art to understand the disclosure. It would be appreciated that the specific embodiments described herein are merely used for explaining the present disclosure, not for limiting.

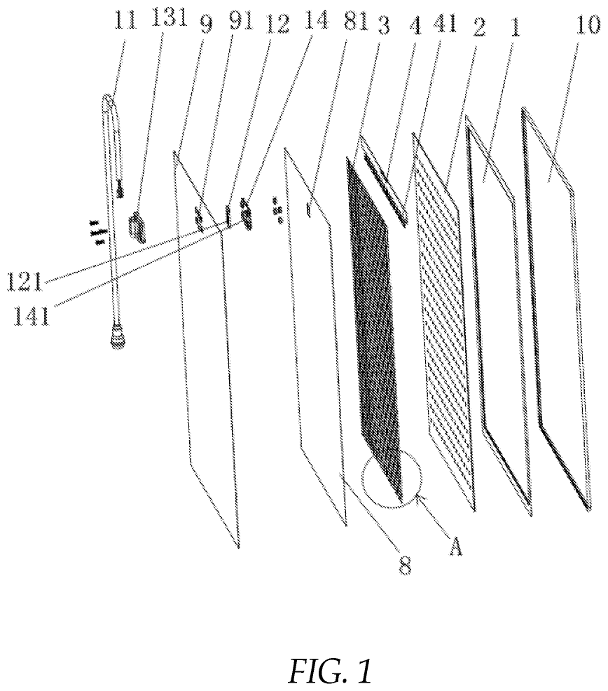

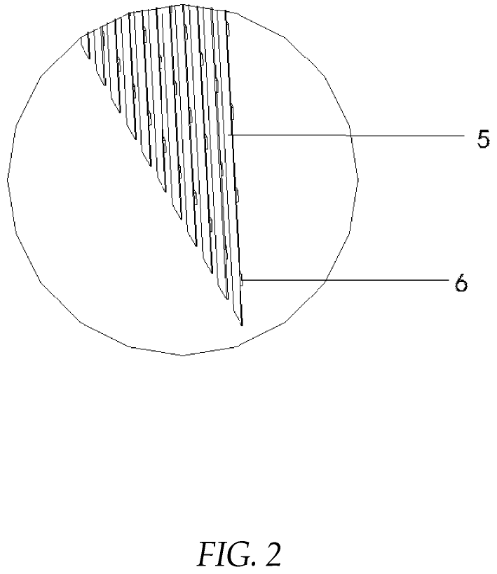

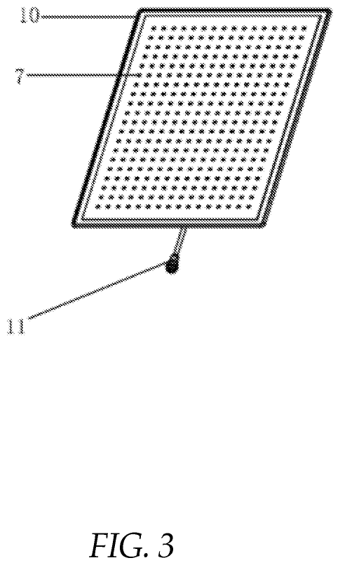

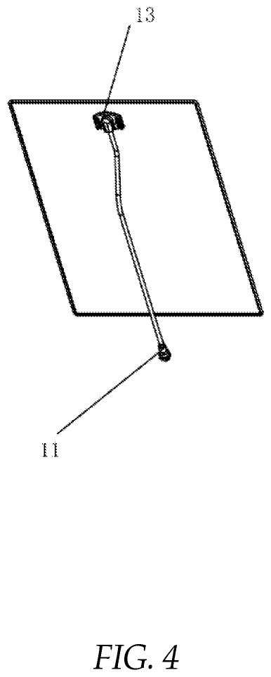

FIGS. 1 to 7 schematically show a curlable lamp of the present disclosure.

### Example 1

As shown in FIGS. 1 to 4, the curlable lamp of the present disclosure comprises an illuminating component and a waterproof soft sheet 1. A flexible lamp bead positioning block 2 is arranged between the illuminating component and the waterproof soft sheet 1. The flexible lamp bead positioning block 2 is bonded and fixed with the waterproof soft sheet 1.

The illuminating component comprises a plurality of lamp bead strips 3, which connect with wiring boards 4. Each lamp bead strip 3 comprises flexible circuit boards 5 and lamp beads 6. The lamp beads 6 are connected in series or in parallel on the flexible circuit boards 5. The lamp beads 6 are LED lamp beads.

The wiring boards 4 comprise a plurality of interfaces 41. The flexible circuit boards 5 are inserted in the interfaces 41 to electrically connect with the wiring boards 4. The number of interfaces 41 is the same as the number of flexible circuit boards 5.

Hole sites 7 are arranged on the flexible lamp bead positioning block 2 at positions corresponding to the lamp beads 6. The shape and size of the hole sites 7 are matched with the lamp beads 6. Adhesive is provided in the hole sites 7. The lamp beads 6 are bonded and fixed in the hole sites 7 with the adhesive. The number of hole sites 7 is the same as the number of lamp beads 6 to ensure that each lamp bead 6 is bonded and fixed in the hole sites 7.

The lamp beads 6 are fixed by bonding, so that the lamp beads 6 are more compact and more integrated. Especially when the lamp is curled, the lamp beads 6 do not be disarrayed, so that the light effect is more uniform. During maintenance, only the lamp bead strips 3 to be repaired needs to be taken down and replaced, which is convenient and fast.

A metal film radiator 8 is arranged on the backs of the lamp bead strip 3. The metal film radiator 8 fits the backs of the lamp bead strips 3. During the actual installation process, the backs of the lamp bead strips 3 are coated with adhesive and the metal film radiator 8 is fixed on the backs of the lamp bead strips 3 by adhesive bonding, so that the heat generated by the lamp beads 6 is quickly dissipated through the metal film radiator 8 and the service life of the lamp beads 6 is prolonged.

A waterproof cloth 9 is arranged on the back of the metal film radiator 8. The waterproof cloth 9 and the four sides of the waterproof soft sheet 1 are fixedly bonded by ultrasonic wave. The metal film radiator 8, the flexible lamp bead positioning block 2 and the illuminating component are clamped between the waterproof cloth 9 and the waterproof soft sheet 1. The metal film radiator 8 can further transfer the heat generated by the lamp beads 6 to the waterproof cloth 9 for heat dissipation. The waterproof cloth 9 and the waterproof soft sheet 1 play a waterproof role to prevent water from penetrating into the interior, which causes the lamp beads to be short-circuited and unusable. A hem 10 is arranged on overlapping formed after the waterproof cloth 9 and edges of the waterproof soft sheet 1 are bonded, which plays a reinforcing role and increases the roundness and beauty of the lamp edge.

As shown in FIGS. 1 to 4, the curlable lamp of the present disclosure further comprises an input connecting wire 11. A first outlet 91 and a second outlet 81 are arranged on the waterproof cloth 9 and the metal film radiator 8, respectively, through which the input connecting wire 11 passes.

A waterproof rubber pad 12 is arranged between the waterproof cloth 9 and the metal film radiator 8. The waterproof rubber pad 1 is a high-elasticity waterproof silicone pad with excellent waterproof performance. The waterproof rubber pad 12 is fixed on the waterproof cloth 9 through a first input wire fixed base 13 and a second input wire fixed base 14. A third outlet 121, a fourth outlet 131 and a fifth outlet 141 are arranged on the waterproof rubber pad 12, the first input wire fixed base 13 and the second input wire fixed base 14, respectively, through which the input connecting wire 11 passes. The input connecting wire 11 is electrically connected with the wiring board 4 after sequentially passing through the fourth outlet 131, the first outlet 91, the third outlet 121, the fifth outlet 141 and the second outlet 81 The input connecting wire 11 is electrically connected with the lamp bead strips 3 through the wiring board 4, so that the lamp effect of the lamp bead strips 3 can be controlled.

The waterproof rubber pad 12 is fixed on the waterproof cloth 9 through the independent first input wire fixed base 13 and second input wire fixed base 14, which makes the installation convenient and firm and prevents water from penetrating into the interior through the outlet

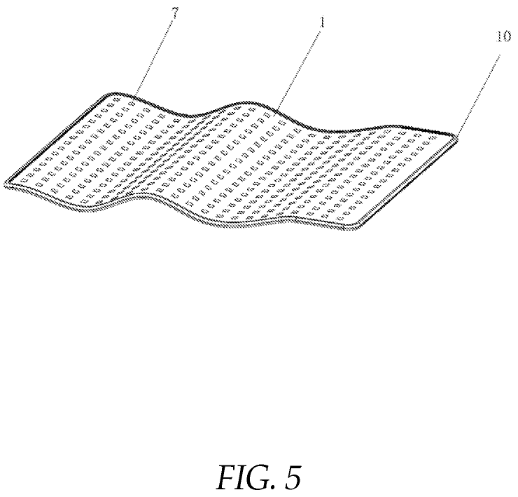

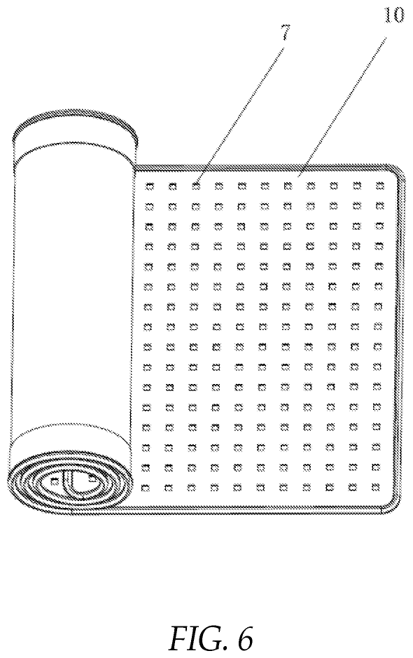

As shown in FIG. 5 and FIG. 6, the curlable lamp of the present disclosure uses flexible materials with bendability. The curlable lamp can show various lighting effects and can be curled to save space when not in use.

### Example 2

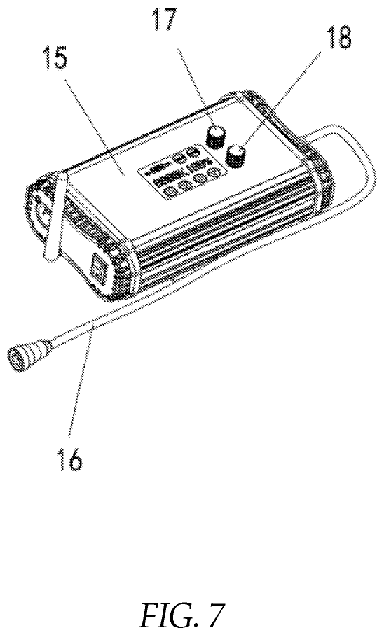

The mere difference between Example 1 and Example 2 is that the curlable lamp of the present disclosure further comprises a light controller. As shown in FIG. 7, the light controller 15 comprises an output connecting wire 16, a light brightness adjusting knob 17, and a light color temperature adjusting knob 18. The output connecting wire 16 is electrically connected with the input connecting wire 11. The light brightness adjusting knob 17 and the light color temperature adjusting knob 18 can adjust the light brightness and color of the lamp beads 6, respectively, to obtain ideal light effect.

The curlable lamp of the present disclosure has good heat dissipation performance. The lamp beads are bonded and fixed so that the curlable lamp is more compact and integrated. Especially when the lamp is curled, the lamp beads will not be disarrayed, so that the light effect is more uniform. During maintenance, only the lamp bead strips to be repaired needs to be taken down and replaced, which is convenient and quick. Additionally, the lamp can be curled to save space when not in use.

It should be noted that, unless otherwise specified, the terms “first”, “second”, etc. in the specification are only used to distinguish various components, elements, steps, etc. in the specification, but not used to indicate logical relationships or sequential relationships between various components, elements, steps, etc.

The above is only some examples of the present disclosure. For one ordinary skilled in the art, several modifications and improvements can be made without departing from the inventive concept of the present disclosure, which are all within the protective scope of the present disclosure.

1. A curlable lamp, comprising an illuminating component and a waterproof soft sheet (1), wherein a flexible lamp bead positioning block (2) is arranged between the illuminating component and the waterproof soft sheet (1), the illuminating component comprises lamp bead strips (3), which connect with wiring boards (4), the lamp bead strips (3) comprise flexible circuit boards (5) and lamp beads (6), the lamp beads (6) are connected in series or in parallel on the flexible circuit boards (5), the wiring boards (4) comprise a plurality of interfaces (41), the flexible circuit boards (5) are inserted in the interfaces (41) to electrically connect with the wiring boards (4), the number of interfaces (41) is the same as the number of flexible circuit boards (5), hole sites (7) are arranged on the flexible lamp bead positioning block (2) at positions corresponding to the lamp beads (6), shapes and sizes of the hole sites (7) are matched with the lamp beads (6), the lamp beads (6) are bonded and fixed in the hole sites (7), and a metal film radiator (8) is arranged on backs of the lamp bead strips (3).

2. The curlable lamp of claim 1, wherein number of the hole sites (7) is the same as number of the lamp beads (6).

3. The curlable lamp of claim 1, wherein a waterproof cloth (9) is arranged on back of the metal film radiator (8), and the waterproof cloth (9) and four sides of the waterproof soft sheet (1) are bonded by ultrasonic wave.

4. The curlable lamp of claim 3, wherein a hem (10) is arranged on overlapping formed after the waterproof cloth (9) and edges of the waterproof soft sheet (1) are bonded.

5. The curlable lamp of claim 3, further comprising an input connecting wire (11), wherein a first outlet (91) and a second outlet (81) are arranged on the waterproof cloth (9) and the metal film radiator (8), respectively, through which the input connecting wire (11) passes, and the input connecting wire (11) is connected with the wiring board (4) after sequentially passing through the first outlet (91) and the second outlet (81).

6. The curlable lamp of claim 5, wherein a waterproof rubber pad (12) is arranged between the waterproof cloth (9) and the metal film radiator (8), the waterproof rubber pad (12) is fixed on the waterproof cloth (9) through a first input wire fixed base (13) and a second input wire fixed base (14); a third outlet (121), a fourth outlet (131) and fifth outlet (141) are arranged on the waterproof rubber pad (12), the first input wire fixed base (13) and the second input wire fixed base (14), respectively, through which the input connecting wire (11) passes; the input connecting wire (11) is connected with the wiring hoard (4) after sequentially passing through the fourth outlet (131), the first outlet (91), the third outlet (121), the fifth outlet (141) and the second outlet (81).

7. The curlable lamp of claim 6, wherein the waterproof rubber pad (12) is a waterproof silicone pad of high elasticity.

8. The curlable lamp of claim 1, wherein the lamp beads (6) are LED lamp beads.

9. The curlable lamp of claim 6, further comprising a light controller (15), wherein the light controller (15) comprises an output connecting wire (16), a light brightness adjusting knob (17) and a light color temperature adjusting knob (18), and the input connecting wire (11) is electrically connected with the output connecting wire (16).
